(19) United States
(12) Patent Application Publication
(10) Pub. No.: US 2024/0424693 A1
(43) Pub. Date: Dec. 26, 2024

(54) POSITIONING ARM WITH 3-DEGREE-OF-FREEDOM GRAVITY COMPENSATION

(71) Applicants: ROEN Surgical, Inc., Daejeon (KR); KOREA ADVANCED INSTITUTE OF SCIENCE AND TECHNOLOGY, Daejeon (KR)

(72) Inventors: Dong Soo KWON, Daejeon (KR); Chang Kyun KIM, Daejeon (KR)

(73) Assignees: ROEN Surgical, Inc., Daejeon (KR); KOREA ADVANCED INSTITUTE OF SCIENCE AND TECHNOLOGY, Daejeon (KR)

(21) Appl. No.: 18/706,137

(22) PCT Filed: Nov. 2, 2022
(86) PCT No.: PCT/KR2022/016987

§ 371 Date: Jul. 31, 2024

(30) Foreign Application Priority Data
Nov. 3, 2021 (KR) 10-2021-0149573

(51) Int. Cl. B25J 18/04; B25J 9/10; B25J 9/16

(52) U.S. Cl. CPC B25J 18/04; B25J 9/102; B25J 9/1638

(57) ABSTRACT

Proposed is a positioning arm with 3-degree-of-freedom gravity compensation, wherein the positioning arm moves an operating tool (10) by using an incision point as remote center of motion (hereinafter, “RCM”) and includes a link assembly portion (100) capable of rotating in the roll and pitch-directions about the RCM, and allowing the operating tool (10) to carry out translational motion in the direction toward the RCM, and a gravity compensator (200) which provides, with respect to torque caused by gravity acting on the link assembly portion (100) and the operating tool (10), compensation torque having a direction opposite to that of the torque.

### TECHNICAL FIELD

The present disclosure relates to a positioning arm with a gravity compensation mechanism applied in three degrees of freedom (3-DoF): roll, pitch, and translation directions. More particularly, the present disclosure is about a technology that allows the position of an operating tool, such as a surgical instrument, to be changed with a small amount of force by counterbalancing all torque caused by gravity, regardless of the position of the operating tool during a surgery or operation. In addition, the present disclosure relates to a positioning arm to which a gravitational torque compensation method that enables easy response to changes in the mass of the operating tool is applied, and to which gravitational torque compensation according to mass asymmetry in the roll direction is applied.

### BACKGROUND ART

Patent Document 001 relates to a gravity compensation mechanism. The gravity compensation mechanism is installed on a link member capable of rotating in multiple directions, and includes: a plurality of bevel gears capable of engaging and rotating according to the rotation of the link member; a cam plate connected to one or more of the bevel gears and rotating together with the one or more of the bevel gears; and a gravity offset portion that is connected to the cam plate and compresses an elastic member according to the rotation of the link member and the cam plate to absorb gravity due to the link member's own weight.

Patent Document 002 relates to a positioning arm including: a base; a rolling body rotatable about a first rotation axis with respect to the base; a pitching link rotatable about a second rotation axis disposed long in a direction intersecting the first rotation axis with respect to the rolling body; a slider capable of sliding in a direction intersecting the first rotation axis and the second rotation axis with respect to the rolling body; a motion conversion module that is connected between the base and the slider and allows the slider to slide relative to the rolling body according to the rotational motion of the rolling body; and an elastic module connected between the slider and the pitch link and formed at least in part thereof from an elastic material.

Patent Document 003 relates to a positioning arm including: a link assembly having a translation link capable of translation along an imaginary axis passing through a remote center of motion (RCM) existing at a constant position from a point, and capable of rotating in at least two directions about the point; and a gravity torque compensator that provides compensation torque in the opposite direction to gravitational torque acting on the point due to the self-weight of the link assembly.

Patent Document 004 relates to a positioning arm including: a link assembly having an end whose distance from a point may vary, and capable of rotating in at least two directions around the point; and a gravity compensator that provides compensation torque in the opposite direction to gravitational torque acting on the point due to the self-weight of the link assembly.

### PATENT DOCUMENT

(Patent Document 001) Korean Patent No. 10-1190228 (registered Oct. 12, 2012)
(Patent Document 002) Korean Patent No. 10-1787265 (registered Oct. 18, 2017)
(Patent Document 003) Korean Patent No. 10-2188210 (registered Dec. 9, 2020)
(Patent Document 004) Korean Patent No. 10-2034950 (registered Oct. 15, 2019)

### DISCLOSURE

### Technical Problem

The present disclosure is intended to provide a positioning arm with a gravity compensation mechanism applied in three degrees of freedom (3-DoF): roll, pitch, and translation directions.

### Technical Solution

The present disclosure relates to a positioning arm with 3-degree-of-freedom gravity compensation, wherein the positioning arm moves an operating tool by using an incision point as remote center of motion (hereinafter, “RCM”) and includes a link assembly portion capable of rotating in the roll and pitch directions about the RCM, and allowing the operating tool to carry out translational motion in the direction toward the RCM, and a gravity compensator which provides, with respect to torque caused by gravity acting on the link assembly portion and the operating tool, compensation torque having a direction opposite to that of the torque.

The present disclosure relates to a positioning arm with 3-degree-of-freedom gravity compensation, wherein the positioning arm moves an operating tool by using an incision point as RCM. In the positioning arm of the present disclosure, the link assembly portion may include: a gearbox capable of roll rotation with respect to a base; a first link capable of pitch rotation with respect to the gearbox; a pair of second links that forms a predetermined angle with the first link, and is movable while the two links that make up the pair remain parallel to each other; and a third link coupled to an end of the pair of second links and capable of linearly moving the operating tool.

The present disclosure relates to a positioning arm with 3-degree-of-freedom gravity compensation, wherein the positioning arm moves an operating tool by using an incision point as RCM. In the positioning arm of the present disclosure, the link assembly portion may include: a gearbox capable of roll rotation with respect to a base, wherein the gearbox may include: a center bevel gear fixed with respect to the base; and a pair of rotational bevel gears in which the gears that make up the pair are respectively engaged on opposite sides of the center bevel gear, and capable of rotating in the roll direction with respect to the center bevel gear.

The present disclosure relates to a positioning arm with 3-degree-of-freedom gravity compensation, wherein the positioning arm moves an operating tool by using an incision point as RCM. In the positioning arm of the present disclosure, the gravity compensator may include: a pair of side moment arms that is combined with the pair of rotational bevel gears to assist in compensating gravitational torque of the link assembly portion generated according to the roll rotation of the gearbox.

The present disclosure relates to a positioning arm with 3-degree-of-freedom gravity compensation, wherein the positioning arm moves an operating tool by using an incision point as RCM. In the positioning arm of the present disclosure, the gravity compensator may include: a roll pitch compensation structure having a pair of first elastic bodies that is interlocked with the pair of side moment arms and provides compensation torque for rotation in the roll and pitch directions.

The present disclosure relates to a positioning arm with 3-degree-of-freedom gravity compensation, wherein the positioning arm moves an operating tool by using an incision point as RCM. In the positioning arm of the present disclosure, the gravity compensator may include: an asymmetry compensation structure that compensates for asymmetric gravity torque due to weight asymmetry of the link assembly portion based on a rotation axis in the roll direction.

The present disclosure relates to a positioning arm with 3-degree-of-freedom gravity compensation, wherein the positioning arm moves an operating tool by using an incision point as RCM. In the positioning arm of the present disclosure, the asymmetry compensation structure may include: a pair of second elastic bodies; and a second slider coupled to a side of the pair of second elastic bodies and capable of linear motion.

The present disclosure relates to a positioning arm with 3-degree-of-freedom gravity compensation, wherein the positioning arm moves an operating tool by using an incision point as RCM. In the positioning arm of the present disclosure, the gravity compensator may include: a counterweight that compensates for changes in gravitational torques in the roll and pitch directions of the link assembly portion stemming from a change in position in position due to the translational motion of the operating tool, and that compensates for changes in a residual external force in a direction of the translational motion acting on the operating tool.

The present disclosure relates to a positioning arm with 3-degree-of-freedom gravity compensation, wherein the positioning arm moves an operating tool by using an incision point as RCM. In the positioning arm of the present disclosure, when the operating tool moves in a straight line to approach the incision point, the counterweight moves linearly in a direction opposite to a movement direction of the operating tool.

The present disclosure relates to a positioning arm with 3-degree-of-freedom gravity compensation, wherein the positioning arm moves an operating tool by using an incision point as RCM. The positioning arm of the present disclosure may further include: a third wire whose length is adjusted according to a movement of the operating tool and having a first end connected to the counterweight; and a conversion bearing for changing a direction of the third wire.

The present disclosure relates to a positioning arm with 3-degree-of-freedom gravity compensation, wherein the positioning arm moves an operating tool by using an incision point as RCM. The positioning arm of the present disclosure may further include: a timing pulley that rotates according to the movement of the operating tool; and a capstone pulley that rotates coaxially with the timing pulley and on which a second end of the third wire is wound.

The present disclosure relates to a positioning arm with 3-degree-of-freedom gravity compensation, wherein the positioning arm moves an operating tool by using an incision point as RCM. In the positioning arm of the present disclosure, a movement amount of the counterweight is determined depending on a gear ratio of the timing pulley and the capstone pulley.

### Advantageous Effects

According to the present disclosure, torques due to gravity can be fully compensated in three degrees of freedom (3-DoF): roll, pitch, and translation directions.

Due to this, the position of a surgical instrument can be freely varied, and by providing a counterweight, it is possible to overcome the shortcomings of conventional positioning arms where gravity compensation is not achieved completely in the case of a change in the mass of an operating tool and to easily provide gravitational torque compensation by replacing the mass of the counterweight even when the mass of an operating tool changes.

Furthermore, according to the present disclosure, due to an asymmetric compensation structure, it is possible to compensate for gravitational torque of a positioning arm, which is asymmetric with respect to a plane perpendicular to the pitch axis and including the roll axis.

### DESCRIPTION OF DRAWINGS

FIG. 1 is a perspective view of a conventional positioning arm in which variable gravity compensation is limited depending on the change in mass of an operating tool;

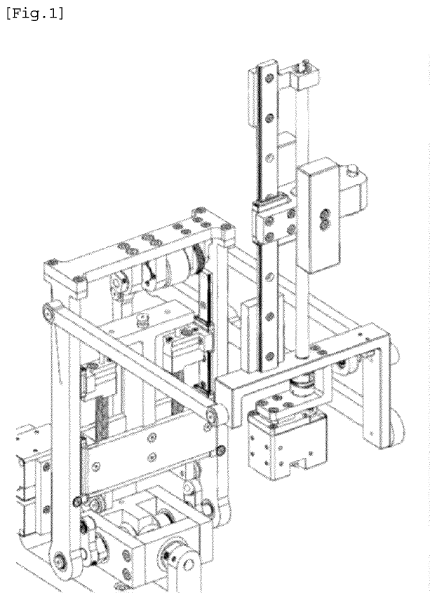

FIG. 2 is a perspective view of a positioning arm according to an embodiment of the present disclosure;

FIG. 3 is a perspective view of a joint applied to a positioning arm according to an embodiment of the present disclosure;

FIG. 4 is an enlarged perspective view of a roll pitch compensation structure according to an embodiment of the present disclosure;

FIG. 5 is a perspective view of an enlarged perspective view of an asymmetric compensation structure according to an embodiment of the present disclosure;

FIG. 6 is a view showing the operation of a counterweight according to an embodiment of the present disclosure;

FIG. 7 is a view showing an operational relationship between an operating tool and a counterweight; and

FIG. 8 is a schematic view of a positioning arm according to an embodiment of the present disclosure.

### MODE FOR INVENTION

Hereinafter, in order to explain the present disclosure in detail so that a person skilled in the art can easily practice the present disclosure, preferred embodiments of the present disclosure will be described in detail.

Numbers cited in an embodiment below are not limited to the objects of citation and may be applied to all embodiments. An object that has the same purpose and effect as the configuration presented in the embodiments is an equivalent replacement object. High-level concept objects presented in the embodiments include low-level concept objects that are not described.

Minimally invasive surgery (MIS) is an approach to surgery that minimizes surgical scars by minimizing incisions during a surgery. Since a minimally invasive surgical procedure is performed by making a small incision in the patient's body and inserting a long rod-shaped surgical instrument, it is very difficult to control the surgical instrument. Accordingly, many robotic surgical systems have been developed to help doctors perform surgery intuitively using robots.

For such a surgical robot, if gravitational torque of a positioning arm is not compensated, the positioning arm may move due to gravity in an unpowered state, resulting in serious injury to a patient. Thus, offsetting the gravitational torque acting on the surgical robot is necessary.

When the torque due to gravity is fully compensated, the same effect as if moving in zero gravity can be achieved even if a surgical instrument is moved in the roll, pitch, and translation directions. This allows surgical instruments to be moved smoothly even when using smaller actuators. Hereinafter, various embodiments of a positioning arm of the present disclosure will be described.

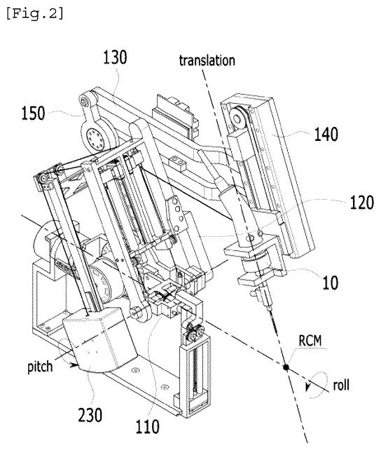

As shown in FIG. 2, the roll direction, pitch direction, and translation direction described in the present disclosure are defined as the horizontal rotation direction, vertical rotation direction, and linear motion direction, respectively, based on an incision point.

(Example 1-1) Provided is a positioning arm with three-degree-of-freedom (3-DoF) gravity compensation, wherein the positioning arm moves an operating tool 10 by using an incision point as remote center of motion (hereinafter, “RCM”) and includes: a link assembly portion 100 capable of rotation in the roll and pitch directions about the RCM, and allowing the operating tool 10 to carry out translational motion in the direction toward the RCM; and a gravity compensator 200 which provides, with respect to torque caused by the gravity acting on the link assembly portion 100 and the operating tool 10, compensation torque having a direction opposite to that of the torque.

(Example 1-2) In the Example 1-1, the link assembly portion 100 includes: a gearbox 110 capable of roll rotation with respect to a base 101; a first link 120 capable of pitch rotation with respect to the gearbox 110; a pair of second links 130 that forms a predetermined angle with the first link 120, and is movable while the two links that make up the pair remain parallel to each other; and a third link 140 coupled to one end of the pair of second links 130 and capable of linearly moving the operating tool 10.

The positioning arm of the present disclosure may include the link assembly portion 100 and the gravity compensator 200. The link assembly portion 100 may refer to any structure that holds and adjusts the position of the operating tool 10, which is a surgical instrument or an incision tool. The gravity compensator 200 may serve to compensate for the torque due to gravity acting on the link assembly portion 100 and the operating tool 10 through torque in the opposite direction. The gravity compensator 200 may consist of a spring and a counterweight 230, as will be described later, and details about which will be described later.

(Example 1-3) In the Example 1-2, the link assembly portion 100 includes a connection link 150 connected to the other end of the pair of second links 130.

The link assembly portion 100 may include the gearbox 110, the first link 120, the second links 130, and the third link 140. The gearbox 110 may rotate in the roll direction with respect to the base 101 which is fixed, and when the gearbox 110 rolls, the link assembly portion 100 and the operating tool 10 may also rotate in the roll direction.

The first link 120 is configured to rotate in the pitch direction with respect to the gearbox 110, and the second link 130 is provided as a pair that forms a predetermined angle with the first link 120 and is movable while the two links that make up the pair remain parallel to each other. The third link 140 is coupled to one end of the pair of second links 130 and has a configuration capable of causing the operating tool 10 to move linearly (translationally).

As will be described later, the third link 140 may secure the degree of freedom for translational motion of the operating tool 10 by using a capstone pulley 235 and a transfer belt 236. The other end of the pair of second links 130 may be combined with the connection link 150 to be formed integrally with the link assembly portion 100.

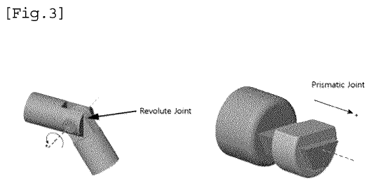

In addition, referring to FIG. 3, for connections between links, a joint may be used. The joint may include a revolute joint and a prismatic joint. The revolute joint may be a joint used in a joint portion in terms of rotational degrees of freedom in the roll or pitch direction, and the prismatic joint may be a joint used in a linear motion portion in terms of translational degrees of freedom.

The present disclosure relates to the positioning arm in which the gravity force acting on the link assembly portion 100 in three degrees of freedom is compensated. To assist in the theoretical explanation of gravity compensation, one-degree-of-freedom (1-DoF) gravity compensation is briefly described as follows.

Gravity compensation may be achieved when the sum of the potential energy due to the spring and the potential energy due to gravity maintains a constant value regardless of the position of the operating tool. The formula for which is as follows.

(Example 2-1) In the Example 1-1, the link assembly portion 100 includes the gearbox 110 capable of rotating in the roll direction with respect to the base 101. The gearbox 110 includes: a center bevel gear 111 fixed with respect to the base 101; and a pair of rotational bevel gears 112 in which the gears that make up the pair are respectively engaged on opposite sides of the center bevel gear 111, and capable of rotating in the roll direction with respect to the center bevel gear 111.

(Example 2-2) In the Example 2-1, the gravity compensator 200 includes a pair of side moment arms 113 that is combined with the pair of rotational bevel gears 112 to assist in compensating the gravitational torque of the link assembly portion 100 generated according to the roll direction rotation of the gearbox 110.

(Example 2-3) In the Example 2-2, the side moment arms 113 rotate in opposite directions as the gearbox 110 rotates in the roll direction.

The link assembly portion 100 may include the gearbox 110, and inside the gearbox 110, the center bevel gear 111 and the rotational bevel gears 112 may be provided. The center bevel gear 111 may be a gear fixedly coupled to the fixed base 101. The rotational bevel gears 112 may rotate in the roll direction together with the gearbox 110 while being engaged on opposite sides of the central bevel gear 111. As the gearbox 110 rotates in the roll direction, the link assembly portion 100 including the operating tool 10 may be rotated as one unit in the roll direction.

In addition, the rotational bevel gears 112 may be respectively connected to the side moment arms 113. The side moment arms 113 may not move relatively during pitch rotation of the link assembly portion 100, but may rotate together with the rotational bevel gears 112 during roll rotation. At this time, the rotation directions of the two side moment arms 113 may be opposite to each other. This is to compensate for the additional gravitational torque generated due to the inclination in the roll direction, and this may generate compensation torque in conjunction with a first elastic body 211, which will be described later.

(Example 3-1) In the Example 2-2, the gravity compensator 200 includes a roll pitch compensation structure 210 having a pair of first elastic bodies 211 that is interlocked with the pair of side moment arms 113 and provides compensation torque for rotation in the roll and pitch directions.

(Example 3-2) In the Example 3-1, the roll pitch compensation structure 210 includes: a pair of first wires 212, with ends of the wires that make up the pair are respectively connected to the side moment arms 113; a first slider 213 connected to the other end of the pair of first wires 212 and located on one side of the first elastic body 211; and a first support 214 coupled to the first link 120 and supporting the other side of the first elastic body 211.

(Example 3-3) In the Example 3-2, a straight guide 215 that limits the direction of motion of the first slider 213 is included.

The gravity compensator 200 of the present disclosure may include the roll pitch compensation structure 210. The roll pitch compensation structure 210 may be configured to compensate for the gravitational torque generated as the link assembly portion 100 rotates in the roll direction and/or pitch direction. The roll pitch compensation structure 210 may provide torque that is deformed by the pair of first elastic bodies 211. In addition, the roll pitch compensation structure 210 may include the pair of first wires 212, with ends of the wires that make up the pair are respectively connected to the side moment arms 113; and the first slider 213 connected to the other end of the pair of first wires 212 and located on one side of the first elastic body 211.

In addition, the first support 214 is configured to fix and support the other side of the first elastic body 211, and the first support 214 and the first slider 213 may be located on opposite sides of the first elastic body 211. As the link assembly portion 100 rotates in the pitch direction, the distance between the first slider 213 and the first support 214 may be changed. When the link assembly portion 100 rotates in the roll direction, as the side moment arms 113 rotate in opposite directions, the two first wires 212 may provide elastic forces of different strengths, thereby providing compensation torque in response to the changing gravity torque in the roll direction.

(Example 4-1) In the Example 1-1, the gravity compensator 200 includes an asymmetry compensation structure 220 that compensates for the asymmetric gravity torque due to the weight asymmetry of the link assembly portion 100, based on the rotation axis in the roll direction.

(Example 4-2) In the Example 4-1, the asymmetry compensation structure 220 includes: a pair of second elastic bodies 221; and
a second slider 222 coupled to one side of the pair of second elastic bodies 221 and capable of linear motion.

A second wire 223 that has one end coupled to the second slider 222 and the other end coupled to the link assembly portion 100 to provide asymmetric compensation torque is provided.

(Example 4-3) In the Example 4-2, a second support 224 supporting the other side of the pair of second elastic bodies 221 is provided.

The gravity compensator 200 of the present disclosure may include the asymmetry compensation structure 220 that compensates for the torque due to gravity acting on the asymmetric link assembly portion 100 and the operating tool 10, based on the rotation axis in the roll direction.

In addition, unlike the roll pitch compensation structure 210, the asymmetry compensation structure 220 is not integrally coupled with the first link 120, whose position changes depending on the position of the operating tool 10, but may be provided in an external housing 225 that is stationary with respect to the external coordinate system.

In addition, the asymmetry compensation structure 220 may include the second elastic body 221, the second slider 222, and the second support 224. The second elastic body 221 may basically be a spring, but is not necessarily limited thereto, and a person skilled in the art may use various widely known elastic means in addition to springs.

The second slider 222 and the second support 224 may be located in opposite directions with respect to the second elastic body 221. As the distance between the second slider 222 and the second support 224 changes as needed, the gravitational torque due to asymmetry may be variably compensated. The specific mathematical relationship will be described later.

(Example 5-1) In the Example 1-1, the gravity compensator 200 includes the counterweight 230 that compensates for changes in gravitational torques in the roll and pitch directions of the link assembly portion 100 stemming from the change in position due to the translational motion of the operating tool 10, and that compensates for changes in residual external force in the direction of translation acting on the operating tool 10.

The counterweight 230 of the present disclosure may be positioned as shown in FIGS. 2, 6, and 7 to compensate for changes in torque in the roll and pitch directions of the link assembly portion 100 stemming from the translational motion of the operating tool 10. The counterweight 230 may also compensate for external force in the direction of translational motion of the operating tool 10, specific details of which are described below.

(Example 5-2) In the Example 5-1, when the operating tool 10 moves in a straight line to approach the incision point, the counterweight 230 moves linearly in the opposite direction to the straight line movement of the operating tool 10.

(Example 5-3) In the Example 5-1, a third wire 231 whose length is adjusted according to the movement of the operating tool 10 and whose end is connected to the counterweight 230, and a conversion bearing 232 for changing the direction of the third wire 231 are included.

(Example 5-4) In the Example 5-3, a weight guide 233 that limits the direction of motion of the counterweight 230 is included.

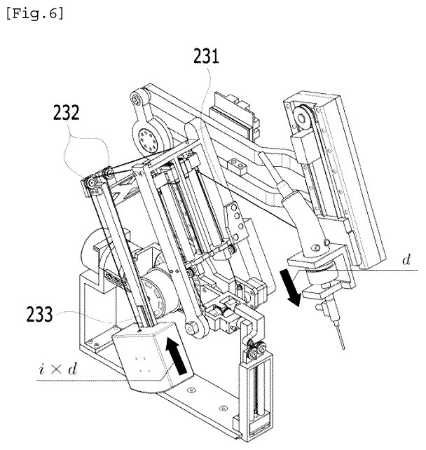

As shown in FIG. 6, the counterweight 230 may be designed to move in a direction opposite to the direction of motion of the operating tool 10. That is, when the operating tool 10 moves in a straight line to approach the incision point, the counterweight 230 may move linearly in a direction opposite to the movement direction of the operating tool 10, and when the operating tool 10 moves in a straight line to move away from the incision point, the counterweight 230 may also move in a direction opposite to the movement direction of the operating tool 10.

To this end, the third wire 231, the conversion bearing 232, and a weight guide 233 may be further included. The length of the third wire 231 may be adjusted according to the amount of movement in the translation direction of the operating tool 10 to move the position of the counterweight 230. However, the movement amount of the operating tool 10 and the movement amount of the counterweight 230 may be different.

(Example 5-5) In the Example 5-3, a timing pulley 234 that rotates according to the movement of the operating tool 10, and the capstone pulley 235 that rotates coaxially with the timing pulley 234 and is wound around the other end of the third wire 231 are included.

(Example 5-6) In the Example 5-5, the transfer belt 236 capable of moving the operating tool 10 as the transfer belt 236 is wound around the timing pulley 234 and rotates is included.

(Example 5-7) In the Example 5-5, the amount of movement of the counterweight 230 is determined by gear ratios of the timing pulley 234 and the capstone pulley 235.

The timing pulley 234, the capstone pulley 235, and the transfer belt 236 may be included in order to move the operating tool 10 in the direction of translational motion. Movement in the direction of translational motion of the operating tool 10 may be accompanied by rotation of the transfer belt 236 configured to be driven in an endless orbit. When the transfer belt 236 rotates, the timing pulley 234 whose outer peripheral surface is in contact with the transfer belt 236 may rotate. When the timing pulley 234 rotates, the capstone pulley 235 rotating on the same axis may rotate. The other end of the third wire 231 may be wound around the capstone pulley 235. Since the opposite one end of the third wire 231 is connected to the counterweight 230, the counterweight 230 may move according to the direction of translational motion of the operating tool 10.

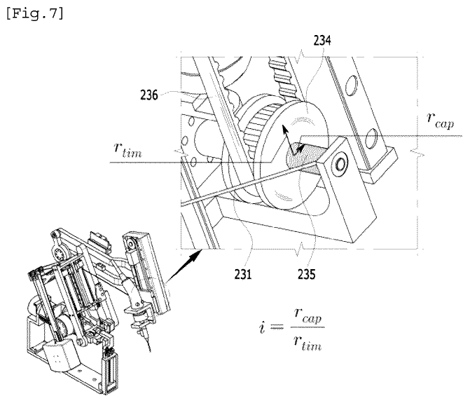

In addition, the third wire may be configured to link the movement of the operating tool 10 and the movement of the counterweight 230. As both ends of the third wire 231 are wound around the capstone pulley 235, two extending third wires 231 may be connected to the counterweight 230 as shown in FIG. 7. If only one end of the third wire 231 is connected to the counterweight 230, when the link assembly portion 100 is tilted more than 90 degrees relative to the roll rotation axis, the counterweight 230 may move without restriction toward the ground due to gravity. In the present disclosure, since both ends of the third wire 231 are fastened to the top and bottom of the counterweight 230, respectively, the counterweight 230 may be used to stably provide a gravity compensation effect to the operating tool 10 regardless of the degree of inclination of the link assembly portion 100.

In addition, the ratio of movement amounts of the operating tool 10 and the counterweight 230 may be determined according to the radius ratio of the capstone pulley 235 and the timing pulley 234. For example, the larger the radius of the timing pulley 234 compared to the radius of the capstone pulley 235, the smaller the movement amount of the counterweight 230 depending on the movement amount of the operating tool 10.

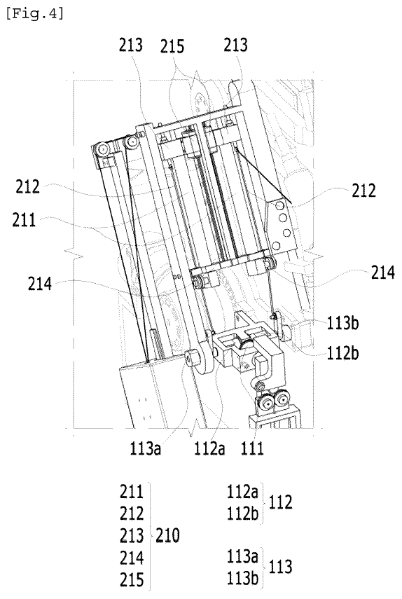

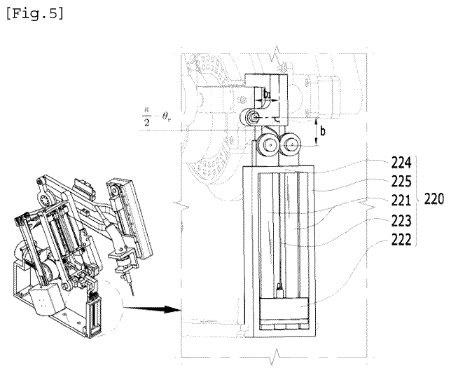

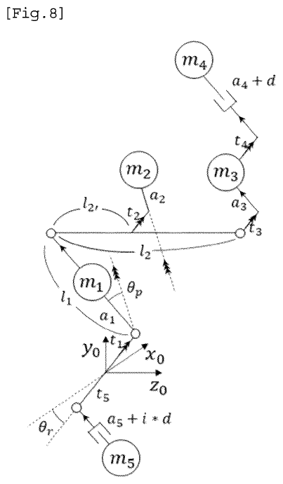

Hereinafter, with reference to FIGS. 2 to 8, focusing on FIG. 8, the structural relationship of the present disclosure will be described on the basis of formula.

θᵣ And θₚ represent the inclination angles in the roll direction and pitch direction, respectively, k₁, h₁, h represent the elastic modulus of the roll pitch compensation structure 210 and the lengths of the two moment arms, and k₂, b₁, b represent the elastic modulus of the asymmetry compensation structure 220 and the lengths of the two moment arms. t represents the gear ratio, and is a value that may be determined according to the radius ration of the timing pulley 234 and the capstone pulley 235, as previously mentioned. In addition, rⱼ, one of the core elements of the present disclosure, is a variable that may express asymmetry and may be a value that may be compensated by the asymmetry compensation structure 220 described above. In addition, the masses of the operating tool 10 and the counterweight 230 may be expressed as m₄,m₅ respectively. Hereinafter, descriptions of overlapping variables will be omitted.

### [Equation 2]

aᵢ: distance between the COM of mᵢ and the center of rotation
m₁: mass of robot at 1^{st} links
m₂: mass of robot at 2^{nd} links
m₃: mass of robot at 3^{rd} links
m₄: mass of translation mass
m₅: mass of counterweight
tⱼ (j=1˜5): off-center distance
Iᵢ: distance of each link
d: translationally moving distance
I: reduction ratio

When calculating the gravitational potential energy for the link assembly portion 100 and the operating tool 10, the following calculation formula is derived.

$${V}_{g} = g \{ sin ( {θ}_{r} ) \{ {m}_{1} {t}_{1} + {m}_{2} ( {t}_{1} + {t}_{2} ) + {m}_{3} ( {t}_{1} + {t}_{3} ) + {m}_{4} ( {t}_{1} + {t}_{3} + {t}_{4} ) - {m}_{5} {t}_{5} \} + cos ( {θ}_{r} ) cos ( {θ}_{p} ) \{ {m}_{1} {a}_{1} + {m}_{2} ( {I}_{1} + {a}_{2} ) + {m}_{3} ( {I}_{1} + {a}_{3} ) + {m}_{4} ( {I}_{1} + {a}_{3} + {a}_{4} + \text{?} ) - {m}_{5} ( \text{?} ) \} \} \qquad [ Equation 3 ]$$

$$\text{?} \text{indicates text missing or illegible when filed}$$

In the above formula, the first underlined part may be a term related to the gravitational torque due to asymmetry, and the second underlined part may be a term related to the translation direction movement (d) of the operating tool 10.

For gravity compensation, if the relationship between the variables below is satisfied,

$${m}_{t} = \frac{{m}_{4}}{i} \& {t}_{1} + {t}_{3} + {t}_{4} = \frac{{t}_{5}}{i} \& {l}_{1} + {a}_{3} + {a}_{4} = \frac{{a}_{5}}{i} \qquad [ Equation 4 ]$$

the term related to the translation direction movement of the operating tool 10 is removed, and the gravitational potential energy may be expressed as follows.

$${V}_{g} = g [ sin ( {θ}_{r} ) \{ {m}_{1} {t}_{1} + {m}_{2} ( {t}_{1} + {t}_{2} ) + {m}_{3} ( {t}_{1} + {t}_{3} ) \} + cos ( {θ}_{r} ) cos ( {θ}_{p} ) \{ {m}_{1} {a}_{1} + {m}_{2} ( {l}_{1} + {a}_{2} ) + {m}_{3} ( {l}_{1} + {a}_{3} ) \} ] \qquad [ Equation 5 ]$$

To explain the above equation, the gravitational potential energy may be divided into a gravitational energy term related to asymmetry as in the equation in the first line and a gravitational energy term related to 3-DoF movement as in the equation in the second line.

For the equation in the second line among the first and second line equations, the term related to the translation direction movement of the operating tool 10 may be compensated (removed) by specifying the mass and position of the counterweight 230 as a special case.

That is, the conditions for corresponding to the parameters of the counterweight 230 may be obtained as above, and as a result, the gravitational potential energy in which changes due to the translation direction movement are compensated may be obtained.

Next, by calculating the elastic potential energy by the first elastic body and the second elastic body 221, following equation may be derived.

$${V}_{k} = {k}_{1} ( {h}^{2} + {h}_{1}^{2} ) - 2 cos ( {θ}_{r} ) cos ( {θ}_{p} ) {k}_{1} {h}_{1} h + \frac{{k}_{2} ( {b}^{2} + {b}_{1}^{2} )}{2} - {k}_{2} {bb}_{1} cos ( \frac{π}{2} - {θ}_{r} ) \qquad [ Equation 6 ]$$

In this case, the first underlined part may consist of the potential energy stemming from the roll pitch compensation structure 210, and the second underlined part may consist of the potential energy from the asymmetry compensation structure 220. As previously described, the elastic modulus of the first elastic body 211 is expressed as k₁, and the elastic modulus of the second elastic body 221 is expressed as k₂.

Therefore, regarding torques in the roll, pitch, and translation directions, the relationship between variables in which torques due to gravity exerted on the link assembly portion 100 and the operating tool 10 according to the rotation angle and translational movement are all cancelled out by the gravity compensator 200 may be derived as follows.

$${τ}_{r} = {τ}_{r , g} + {τ}_{r , k} = \frac{\partial V \text{?}}{\partial {θ}_{r}} + \frac{\partial {V}_{k}}{\partial {θ}_{r}} = - sin ( {θ}_{r} ) cos ( {θ}_{p} ) [ g \{ {m}_{1} + {a}_{1} + {m}_{2} ( \text{?} + {a}_{2} ) + {m}_{3} ( \text{?} + {a}_{1} ) \} - 2 \text{?} {h}_{1} h ] + cos ( {θ}_{r} ) [ g \{ {m}_{1} {t}_{1} + {m}_{2} ( t \text{?} + {t}_{2} ) + {m}_{3} ( {t}_{1} + {t}_{3} ) \} - k \text{?} {bb}_{1} ] \qquad [ Equation 7 ]$$

$${τ}_{p} = {τ}_{p , g} + {τ}_{p , k} = \frac{\partial {V}_{g}}{\partial {θ}_{p}} + \frac{\partial {V}_{k}}{\partial {θ}_{p}} = - cos ( {θ}_{r} ) sin ( {θ}_{p} ) [ g \{ {m}_{1} {a}_{2} + {m}_{2} ( \text{?} + {a}_{2} ) + {m}_{3} ( \text{?} + {a}_{3} ) \} - 2 {k}_{1} {h}_{2} h ]$$

$${τ}_{d} = {τ}_{d , g} + {τ}_{d , k} = \frac{\partial {V}_{g}}{\partial d} + \frac{\partial {V}_{k}}{\partial d} = 0$$

$$\text{?} \text{indicates text missing or illegible when filed}$$

In the calculation formula for torque above, in order for the torques in the roll, pitch, and translation directions to be zero regardless of the inclination angle in the roll direction or pitch direction, the following variable relationships need to be satisfied.

$$2 {k}_{1} {h}_{1} h = g \{ {m}_{1} {a}_{1} + {m}_{2} ( {l}_{1} + {a}_{2} ) + {m}_{3} ( {l}_{1} + {a}_{3} ) \} \qquad [ Equation 8 ]$$

$${k}_{2} {b}_{1} b = g \{ {m}_{1} {t}_{1} + {m}_{2} ( {t}_{1} + {t}_{2} ) + {m}_{3} ( {t}_{1} + {t}_{3} ) \}$$

The first equation may be a variable relationship for the roll pitch compensation structure, and the second first equation may be a variable relationship for the asymmetry compensation structure. In conclusion, when the two variable relationships are satisfied, the positioning arm of the present disclosure may be operated as a device in which gravity is compensated for the three degrees of freedom.

In the above, although preferred embodiments of the present disclosure have been shown and described, the present disclosure is not limited to the specific embodiments described above, and various modifications and implementations of the present disclosure may be made by those skilled in the art without departing from the gist of the present disclosure as claimed in the claims, and these modifications and implementations should not be understood as separate from the technical idea or outlook of the present disclosure.

### DESCRIPTIONS OF NUMERALS

100: link assembly portion
110: gearbox
111: center bevel gear
112: rotational bevel gear
113: side moment arm
120: first link
130: second link
140: third link
200: gravity compensator
210: roll pitch compensation structure
211: first elastic body
212: first wire
213: first slider
214: first support
220: asymmetry compensation structure
221: second elastic body
222: second slider
223: second wire
224: second support
230: counterweight
231: third wire
232: conversion bearing
233: weight guide
234: timing pulley
235: capstone pulley
236: transfer belt
10: operating tool

1. A positioning arm with three-degree-of-freedom (3-DoF) gravity compensation that moves an operating tool (10) by using an incision point as remote center of motion (hereinafter, “RCM”), the positioning arm comprising:
a link assembly portion (100) capable of rotating in roll and pitch directions about the RCM, and allowing the operating tool (10) to carry out translational motion in a direction toward the RCM; and
a gravity compensator (200) which provides, with respect to torque caused by gravity acting on the link assembly portion (100) and the operating tool (10), compensation torque having a direction opposite to that of the torque.

2. The positioning arm of claim 1, wherein the link assembly portion (100) comprises:
a gearbox (110) capable of roll rotation with respect to a base (101);
a first link (120) capable of pitch rotation with respect to the gearbox (110);
a pair of second links (130) that forms a predetermined angle with the first link (120), and is movable while the two links that make up the pair remain parallel to each other; and
a third link (140) coupled to an end of the pair of second links (130) and capable of linearly moving the operating tool (10).

3. The positioning arm of claim 1, wherein the link assembly portion (100) comprises:
a gearbox (110) capable of roll rotation with respect to a base (101),
wherein the gearbox (110) comprises:
a center bevel gear (111) fixed with respect to the base (101); and
a pair of rotational bevel gears (112) in which the gears that make up the pair are respectively engaged on opposite sides of the center bevel gear (111), and capable of rotating in the roll direction with respect to the center bevel gear (111).

4. The positioning arm of claim 3, wherein the gravity compensator (200) comprises:
a pair of side moment arms (113) that is combined with the pair of rotational bevel gears (112) to assist in compensating gravitational torque of the link assembly portion (100) generated according to the roll rotation of the gearbox (110).

5. The positioning arm of claim 4, wherein the gravity compensator (200) comprises:
a roll pitch compensation structure (210) having a pair of first elastic bodies (211) that is interlocked with the pair of side moment arms (113) and provides compensation torque for rotation in the roll and pitch directions.

6. The positioning arm of claim 1, wherein the gravity compensator (200) comprises:
an asymmetry compensation structure (220) that compensates for asymmetric gravity torque due to weight asymmetry of the link assembly portion (100) based on a rotation axis in the roll direction.

7. The positioning arm of claim 6, wherein the asymmetry compensation structure (220) comprises:
a pair of second elastic bodies (221); and
a second slider (222) coupled to a side of the pair of second elastic bodies (221) and capable of linear motion.

8. The positioning arm of claim 1, wherein the gravity compensator (200) comprises:
a counterweight (230) that compensates for changes in gravitational torques in the roll and pitch directions of the link assembly portion (100) stemming from a change in position in position due to the translational motion of the operating tool (10), and that compensates for changes in a residual external force in a direction of the translational motion acting on the operating tool (10).

9. The positioning arm of claim 8, wherein when the operating tool (10) moves in a straight line to approach the incision point, the counterweight (230) moves linearly in a direction opposite to a movement direction of the operating tool (10).

10. The positioning arm of claim 8, further comprising:
a third wire (231) whose length is adjusted according to a movement of the operating tool (10) and having a first end connected to the counterweight (230); and
a conversion bearing (232) for changing a direction of the third wire (231).

11. The positioning arm of claim 10, further comprising:
a timing pulley (234) that rotates according to the movement of the operating tool (10); and
a capstone pulley (235) that rotates coaxially with the timing pulley (234) and on which a second end of the third wire (231) is wound.

12. The positioning arm of claim 11, wherein a movement amount of the counterweight (230) is determined depending on a gear ratio of the timing pulley (234) and the capstone pulley (235).
